(19) United States
(12) Patent Application Publication
(10) Pub. No.: US 2025/0282275 A1
(43) Pub. Date: Sep. 11, 2025

(54) POP-UP ROOF FOR A RECREATIONAL VEHICLE AND RECREATIONAL VEHICLE THEREOF

(71) Applicant: Thor Tech, Inc., Elkhart, IN (US)

(72) Inventors: Dominik Hepe, Ravensburg (DE); Oliver Reuther, Bergatreute (DE); Marcus Metzler, Bad Waldsee (DE); Günter Dorn, Schlier (DE)

(21) Appl. No.: 19/069,569

(22) Filed: Mar. 4, 2025

(30) Foreign Application Priority Data
Mar. 5, 2024 (DE) 10 2024 124 547.6

(51) Int. Cl. B60P 3/34; B60J 1/12; B60J 1/18; B60J 7/16; B60R 7/00

(52) U.S. Cl. CPC B60P 3/34; B60J 1/12; B60J 1/1807; B60J 7/165; B60R 7/005

(57) ABSTRACT

The invention relates to a pop-up roof for a recreational vehicle, with a roof element which is arranged on a roof of a recreational vehicle and can be transferred from a lower driving position into a raised living/sleeping position, wherein in the raised living/sleeping position, a living/sleeping area is formed between the roof element and the roof of the recreational vehicle, which area is accessible from the interior of the recreational vehicle, wherein the living/sleeping area, in the raised living/sleeping position, has at least one sitting height (h) over at least ⅔ of its area, wherein the sitting height (h) is at least 75 cm, preferably at least 80 cm, more preferably at least 85 cm. Preferably, a side wall has at least one dimensionally stable and/or thermally insulating layer.

### CROSS-REFERENCE TO RELATED APPLICATIONS

This application claims priority to German Application Number 10 2024 124 547.6 filed Mar. 5, 2024, the disclosure of which is hereby incorporated by reference in its entirety.

### FIELD

The invention relates to a pop-up roof for a recreational vehicle and to a recreational vehicle with a pop-up roof.

### BACKGROUND

The extension of the living space of recreational vehicles by means of pop-up roofs has long been known and has previously been used to create sleeping spaces or to generate standing height. In the majority of solutions on the market, the roof is positioned so that it is higher at the front in the direction of travel. Therefore, access to the sleeping roof must be planned on the higher side, i.e. at the front, directly behind the driver's seat. Towards the rear, however, the roof of the pop-up roof slopes down sharply. In order to have enough space for sleeping and not bump against the roof, one's head should be on the high side of the roof when sleeping. Therefore, a user has to turn around after getting in, which is often complicated with 2 people, possibly including one person who is already sleeping. The same problem occurs with recreational vehicles with a roof that is higher at the rear in the direction of travel since one then gets in at the rear of the vehicle (i.e. at the higher part of the roof). Furthermore, when the ground is sloping, care should be taken to ensure that the vehicle is parked so that the head end is raised. This creates another problem since people tend to sleep with their heads towards the end of the vehicle, especially in vans or camping buses with lengthwise beds in the lower living area. On sloping ground, there is therefore no possibility of parking the vehicle at the top or bottom for a comfortable sleeping position since perfectly horizontal is not possible.

The invention therefore has the object of reducing the above-mentioned problems of pop-up roofs in recreational vehicles, and in particular of expanding the possible uses of pop-up roofs.

### SUMMARY

The invention achieves this object by a pop-up roof according to claim 1 as well as a recreational vehicle which is equipped with a corresponding pop-up roof. Advantageous embodiments are given in the sub-claims.

The invention provides a pop-up roof for a recreational vehicle, which has a roof element which is arranged or can be arranged on a roof of a recreational vehicle and can be transferred from a lower driving position into a raised living/sleeping position, wherein in the raised living/sleeping position, a living/sleeping area is formed between the roof element and the roof of the recreational vehicle, which area is accessible from the interior of the recreational vehicle. The pop-up roof also has at least one side wall which delimits the living/sleeping area to the outside in the raised living/sleeping position.

The pop-up roof according to the invention is characterized in that the living/sleeping area formed under the roof element of the pop-up roof has at least one sitting height over at least ⅔ of its area in the raised living/sleeping position, wherein the sitting height is at least 75 cm, preferably at least 80 cm, more preferably at least 85 cm. This means that the pop-up roof according to the invention differs considerably from previous solutions in which the pop-up roof in the raised position only has sufficient seating height on one side, while on the other side—the foot side of the sleeping area—it slopes almost down to the floor of the living/sleeping area, or to a height of typically less than 30 cm. Thanks to the minimum height according to the invention, the space under the pop-up roof can be used not only for sleeping, but also as a real living space. This is of interest in particular for compact recreational vehicles such as vans, camping buses, campers and larger cars. These compact recreational vehicles can be parked in normal car parking spaces and therefore allow for particularly versatile use, even in everyday life. However, they offer only limited space in the interior, which is considerably expanded by the pop-up roof according to the invention. For example, the living/sleeping area on the roof of the recreational vehicle can now also be used during the day as a play area for children or a retreat for adults. In addition, an overall higher pop-up roof allows access to the interior of the recreational vehicle to be arranged at any position (front or rear), which yields new floor plan options. In addition to significantly increasing the living value, the invention thus enables new living and floor plan concepts for recreational vehicles. The pop-up roof of the invention is preferably not used to increase the standing height in the interior of the recreational vehicle. That is, under the pop-up roof, an additional living/sleeping area is created with its own floor on the roof and above the (main) interior of the recreational vehicle; it is not just that the (main) interior of the recreational vehicle is extended upwards.

When the roof element is in the raised position, the living/sleeping area has a height over at least ⅔ of its area that permits sitting. Depending on the type of sitting (leaning back or upright) and the size of the person, at least 75 cm is provided for this. To enable taller people to sit upright as well, the sitting height is preferably at least 80 cm, more preferably at least 85 cm. Preferably, in the raised living/sleeping area, the living/sleeping area has at least one sitting height over at least 80%, more preferably over its entire area. Preferably, however, the living/sleeping area does not reach standing height. At the highest point, the height of the living/sleeping area is therefore preferably up to 160 cm, more preferably up to 140 cm, more preferably up to 125 cm. The mentioned heights refer to the room height that is available to the user and are measured in particular in the interior of the living/sleeping area from its floor to the underside of the roof element. The floor of the living/sleeping area is formed by a so-called lower shell of the pop-up roof, which is placed e.g. on the roof of the recreational vehicle.

The pop-up roof is suitable for any type of recreational vehicle, including campers (trailers) and motor homes, as well as panel vans and larger cars. The pop-up roof is particularly suitable for compact recreational vehicles, in particular for panel vans and urban vehicles. In the case of panel vans, also called camper vans, a van is converted into a recreational vehicle while retaining the outer walls. An urban vehicle is understood to mean a larger car that is converted into a recreational vehicle using appropriate built-in elements and a pop-up roof.

The pop-up roof has a roof element which is arranged or can be arranged on the roof of the recreational vehicle. Typically, to form the floor of the living/sleeping area, a lower shell is placed on the roof of the vehicle, into which a mattress can be inserted. The roof element is arranged on top of this and can be moved from a lower driving position into a raised living/sleeping position. This can be done using a lifting mechanism described in more detail below. In the lower driving position, the living/sleeping area is thus folded away. After the vehicle has been parked, the roof element can be raised manually or automatically. The living/sleeping area is equipped with at least one side wall which, in the lower driving position, is located between the roof element and the roof of the recreational vehicle, e.g. in a folded position, and is unfolded when raised to form the side wall which delimits the living/sleeping area from the outside. Preferably, the living/sleeping area is delimited from the outside by a side wall on all four sides, wherein the side wall can also have windows, as explained in more detail below. Advantageously connected or connectable to the interior of the recreational vehicle in the living/sleeping area. This can be done, for example, through an access. The access can be designed as an opening or entry hatch in the roof of the recreational vehicle. Through the opening, a user can reach the living/sleeping area from the interior of the recreational vehicle, e.g. using a ladder. In another embodiment, the access may also be realized as a door or a window in a side wall, which may be an additional access or the only access.

According to a preferred embodiment, in the raised state, the roof element is inclined in a direction of travel of the recreational vehicle and in particular has an angle of 5° to 30°, preferably 8° to 20°, to the horizontal. In special cases, however, it can also be parallel to the roof of the recreational vehicle, i.e. in particular horizontal. The direction of travel of a recreational vehicle is understood here to be the main direction of travel, i.e. the direction from the rear to the front. Preferably, in the raised state, the roof element is thus inclined so that it is higher at the rear or the front. In addition to a more dynamic appearance, this has the considerable advantage that rainwater or snow can flow or slide off better. If the roof is equipped with solar elements, it is also possible to orient the roof towards the sun in order to generate a better solar yield even when the sun is at an angle. Due to the constant sitting height, the inclined position of the roof element is preferably not as steep as with known pop-up roofs, but is preferably less than 30°, for example about 100 to the horizontal. However, it is also quite conceivable that in the raised state, the roof element is at least substantially horizontal. This allows for particularly comfortable use as a living space since the entire area is then equipped with a sitting height and can therefore be accordingly used. Furthermore, embodiments are also conceivable in which the roof element, in the raised state, is inclined in a direction transverse to the direction of travel, preferably with the mentioned angles.

According to a preferred embodiment, in the raised state, the roof element is higher to the back (i.e., at the rear) in the direction of travel. This has the advantage that, especially in camper vans, the living space in the vehicle allows a view to the rear both below and above. Camper vans usually have a rear door through which the rear can be opened completely to the rear. The vehicle is therefore typically parked so that the best view can be seen from the rear. It is advantageous if the living/sleeping area on top is facing the same side. In this way, the living/sleeping area in the pop-up roof is enhanced. In particular, it is advantageous if a viewing window is arranged in a rear side wall of the living/sleeping area. The lower part of the living/sleeping area towards the front in the direction of travel is also advantageously at least high enough so that one can get in/out comfortably and can at least sit upright in each area of the living/sleeping area of the pop-up roof. This means that the room can be used not only for sleeping, but also as a real extension of the living space. In particular, access to the living/sleeping area can be, in the direction of travel, on the side on which the roof element is lower in the raised state, wherein the access is designed in particular as an opening or entry hatch in the roof. Preferably, the access to the living/sleeping area or the entry hatch is at the front in the direction of travel.

According to a preferred embodiment, the at least one side wall, preferably all side walls of the living/sleeping area, has at least one dimensionally stable and/or thermally insulating layer. The reason for this is that the living/sleeping area should advantageously be insulated in order to enable it to be used as living space even in cold weather, e.g. in autumn and winter. In the prior art, a tent fabric is usually used as the wall material which is water-repellent but has no insulating effect with regard to temperature or sound. In addition, the tent fabric is very thin and therefore is not perceived as being a wall. This can cause people with a fear of heights to feel uncomfortable and thus to have difficulty using the living/sleeping area as living space. However, if the walls have a certain thickness and associated dimensional stability, this increases the feeling of security. On the other hand, the side wall should not become too heavy due to the dimensionally stable layer, so that the layer is preferably not or does not include a plastic layer, metal layer, or GRP layer. The side wall preferably also does not include a wooden or sandwich panel.

It should preferably not be completely rigid, but should preferably be compressible so that there is still space in the pop-up roof in the lower driving position. A dimensionally stable and at the same time thermally insulating layer is in particular understood to be a layer made of a foamed or felted material, e.g. made of foam or felt or felt panels. A felt material can already provide a stable, good wall feeling and can be foldable at the same time. Felt provides both a certain degree of dimensional stability and an insulating effect against heat and sound. Foam can also be used in different hardnesses and provides both dimensional stability and heat and sound insulation.

In a preferred embodiment, the side wall has at least one layer of a self-expanding material. This layer is preferably also the dimensionally stable and/or thermally insulating layer. This has the advantage that the layer and thus the side walls take up little space in the lower driving position of the roof element. When the pop-up roof is raised, the self-expanding material is given the space to expand without external propulsion. Due to the self-expanding nature of the material, walls with a previously defined wall thickness are formed without aids such as blowing in air. Due to the deformability and elasticity of these materials, the wall structures return to their original shape when the roof element is raised. During the closing process, i.e. when the roof element is transferred into the lower driving position, the self-expanding material is compressed. Preferably, the layer of self-expanding material is designed such that it folds itself into a specific structure or shape. This can be achieved for example by precisely designed hinges, fold lines, or material thinning.

The self-expanding material can for example be a sponge-like material or a foam material, preferably open-pored. It can also be made from a polymer system. Some polymer materials respond to stimuli such as free space or temperature. These materials can expand or contract under the influence of these stimuli.

In another embodiment, the at least one side wall is designed as a fabric bellows, e.g. made of tent fabric. Furthermore, it is also possible for the at least one side wall to have air-filled hollow chambers. These can be inflated with a compressor or a pump, for example.

The dimensionally stable and/or thermally insulating layer does not have to extend over the entire side wall; it can also be provided only regionally, wherein the dimensionally stable and/or thermally insulating layer preferably extends over a large part of the at least one side wall, for example over more than 80%, preferably more than 90%, particularly preferably over the entire side walls. According to a preferred embodiment, the pop-up roof has 4 side walls, i.e. one each on the front and rear sides in the direction of travel, and two on the two sides. In a preferred embodiment, the side walls are designed softer at the four corners, or the dimensionally stable layer is thinner or non-existent here in order to enable the side walls to be folded or collapsed in the lower driving position. For this purpose, the dimensionally stable and/or thermally insulating layer advantageously has predefined fold or crease lines which can be designed for example as material thinnings or notches. Preferably, these are arranged geometrically, for example circumferentially approximately halfway up the side wall so that the side walls automatically fold inwards when the roof element is folded in. The space remaining under the roof element in the lower driving position is preferably large enough so that at least the folded or retracted side walls are accommodated therein. It is also advantageous to have space for the bedding necessary for sleeping, for example up to 2 pillows and 2 duvets.

The thermally insulating and/or dimensionally stable layer is preferably attached in a non-removable manner and is thus an integral part of the side wall, i.e. it is also present in the pop-up roof in the folded-in lower driving position and is folded out and raised together with the side wall directly by the raising of the pop-up roof. This is in contrast to known retrofitting options in which an insulating layer is manually attached by the user to the fabric bellows of a pop-up roof from the inside. According to one embodiment, the thermally insulating and/or dimensionally stable layer is the sole layer of the side wall, or it is permanently connected to an in particular water-repellent outer layer.

According to a preferred embodiment, the at least one side wall is water-repellent towards the outside. Felt material, for example, can be impregnated and can thus provide the water-repellent function. In this case, i.e. if the thermally insulating layer is impregnable, the at least one side wall can have only the layer of dimensionally stable and/or thermally insulating material. In another embodiment, the at least one side wall of the pop-up roof has a multi-layer construction. In particular, it has an outer water-repellent or waterproof layer, optionally followed by a mosquito net which may only be present in window regions or air or light openings. The water-repellent/waterproof layer can, for example, be made from a tent fabric. Preferably, the water-repellent layer is breathable. For example, it can be designed as a breathable membrane that allows air to pass through but does not allow water in from the outside. Furthermore, the multilayer at least one side wall preferably has a dimensionally stable and/or a thermally insulating layer. Preferably, this layer adjoins the outer layer towards the inside and in particular forms an inner layer. At least regionally, the dimensionally stable and/or thermally insulating layer can be applied to the outer water-repellent layer, e.g. welded or glued on.

The dimensionally stable or self-expanding layer has for example a Shore hardness of between 10 Shore 00 and 70 Shore A, more preferably between 5 Shore A and 40 Shore A. In addition, the material of the layer has e.g. a density of between 10 and 80. Thus, the self-expanding layer can be e.g. in a range of HR1010 and HR8070. The dimensionally stable/self-expanding layer can therefore be present in different forms. In some embodiments it is rather hard like a wall, in other embodiments it is soft and compressible. Preferably, the dimensionally stable layer gives way slightly when a user leans on it or supports themselves against it, but still offers more of the appearance of a wall than pure tent fabric. In preferred embodiments, the side wall with the dimensionally stable layer can function as a backrest when sitting.

The dimensionally stable layer consists, for example, of a foam with the stated hardness and, for example, a thickness between 5 and 70 mm, more preferably between 10 and 40 mm. The foam can be made from PET, recycled PET or other recycled materials. In one embodiment, the foam is self-expanding and acts like a self-inflating sleeping pad.

In another embodiment, the dimensionally stable layer can be a dimensionally stable felt layer, for example with a thickness between 5 and 30 mm. Such a felt layer can be water-repellent on the outside, e.g. impregnated. Felt is stable, offers a good wall feel and is foldable. In addition, felt can be made from sustainable materials.

The at least one side wall can also be made of a mix of materials, for example to achieve a harder wall surface and softer and therefore more flexible corners. The dimensionally stable layer is preferably at the same time insulating. However, it is also possible to separate these functions, e.g. by combining a thin dimensionally stable layer, e.g. made of a thin plastic, fiber-reinforced plastic or a thin mat e.g. made of felt or natural fibers, with a thermally insulating layer, wherein the thermally insulating layer is applied in particular on the inside of the dimensionally stable layer. In this case, the thermally insulating layer can be for example a soft foam. This embodiment has the advantage that the dimensionally stable layer can be interrupted in the corner regions and the fold lines.

The thermally insulating layer, which can form a unit with the dimensionally stable layer, can for example have a heat transfer value (Q-value) of e.g. 0.3 to 2 W/m² K, preferably 0.5-1 W/m² K. Preferably, all materials of the side walls have the property of being able to release absorbed moisture in order to prevent possible mold formation.

A mosquito net can be provided between the outer water-repellent layer and the dimensionally stable or thermally insulating layer, in particular in a window region of the side wall. At such a light opening, the outer water-repellent layer is preferably transparent and is designed for example as a window film e.g. made of a plastic layer. Then comes the mosquito net and the thermally insulating material inside. Preferably, the different layers can be opened individually, the outer water-repellent layer and the mosquito net in particular using zippers. The dimensionally stable or thermally insulating layer can preferably be folded or rolled up inwards, for example over fold lines present in the material such as material thinnings, incisions or film hinges. If the fold lines are arranged vertically on the sides of the window, the internal dimensionally stable and/or thermally insulating layer can preferably be folded inwards like a window shutter. There it can be attached using hook-and-loop fasteners, for example. In another embodiment, the dimensionally stable or thermally insulating layer is folded upwards over a fold line near the roof element, wherein the dimensionally stable and/or thermally insulating layer can then be attached to the roof element at the top, e.g. by means of hook-and-loop fasteners. Alternatively, the dimensionally stable layer in the window region can also be designed to be movable in order to open the light inlet in the window region. In the next step, the user can then open the mosquito net and the outer window material (window film) individually. This allows the user to decide individually which material should be present in the window region or whether everything should be open.

According to a preferred embodiment, a storage unit is integrated on the inside of the at least one wall element, in particular a net, a pocket and/or a fold-out shelf. Such storage options increase the utility value of the space created in the pop-up roof as living space.

According to a preferred embodiment, the at least one side wall has a forced ventilation opening. This is preferably arranged adjacent to or at a distance of less than 10 cm from the roof element, in particular less than 10 cm below the roof element. The forced ventilation opening, of which there may be a plurality, allows air to circulate from bottom to top, i.e. from the interior of the recreational vehicle into the living/sleeping area of the pop-up roof. This chimney effect allows the heat from below to also heat the space above. This means that the living/sleeping area in the pop-up roof can also be used in the cooler seasons. The at least one forced ventilation opening is preferably designed as one or more ventilation slots. Preferably, the at least one forced ventilation opening can also be closed if a user feels disturbed by the slight air circulation. At the same time, however, sufficient ventilation is preferably ensured, either through the breathable material mix or other technical/mechanical solutions such as roof hoods. For example, a forced ventilation opening can be designed as a ventilation grille or a series of slots which can be opened and closed by laterally moving a complementary ventilation grille. Such a ventilation grille can be realized with thin plastic sheets. The at least one forced ventilation opening can also be insulated. In order to create a pleasant room climate, the at least one forced ventilation opening is preferably arranged adjacent to or at a distance of less than 10 cm below the roof element. The distance specification refers to the upper edge of the at least one forced ventilation opening. In this way, warm air from below can heat the living/sleeping area up to the ceiling. In addition, the forced ventilation opening is protected from the weather by the roof element in such a way that in particular no rain can penetrate. Preferably, the at least one forced ventilation opening is arranged on the highest side wall of the living/sleeping area. Alternatively, it can be located on one or both of the lateral side walls.

Alternatively or additionally, the at least one side wall is preferably at least regionally breathable. If the side walls are breathable or have sufficient breathable regions, a forced ventilation opening may not be necessary. Breathability can also be additionally provided to ensure a pleasant room climate in the living/sleeping area. Preferably, the dimensionally stable and/or thermally insulating layer is breathable. Materials suitable for this purpose include felt materials and open-pored foams. The employed tent fabrics are also typically breathable.

According to an alternative embodiment, the living/sleeping area can be heated independently of the interior of the recreational vehicle. This can be achieved for example by installing an air heater or hot water heater or by an electric heating system. In particular, the living/sleeping area can be heated by installing a heating system.

According to a preferred embodiment, the at least one side wall has at least one dimensionally stable layer, wherein in a window region, at least the dimensionally stable layer of the side wall can be folded inwards and/or outwards. With substantially vertical axes, the window can be opened like a shutter. Preferably, the folding elements of the side wall open inwards so that the window region can remain closed by a window film. Preferably, this can also be opened by hook-and-loop fasteners or zippers, wherein the window film is folded outwards or rolled up, for example. It is particularly preferred to fold the dimensionally stable layer around a substantially horizontal axis, in particular above the window region since in this way a canopy can be realized when folding outwards. In this case, the outer layer, if present, is also unfolded. The unfolded wall element can be held up by poles, or alternatively by belt or rope elements attached to the roof element. In this way, it is possible to extend the living/sleeping area by a space in front of the window region, which is then protected from sun and rain by a canopy.

According to a preferred embodiment, the pop-up roof has a panoramic window in a side wall, in particular the side wall with the greatest height, which extends at least over a large part of the width of the side wall in question. This preferably corresponds approximately to the width of the vehicle. A large part of the width is understood to mean in particular more than 80%, preferably more than 90%, particularly preferably the entire width of the side wall. Preferably, this is the side wall with the greatest height, which is preferably oriented rearward in the direction of travel. The panoramic window is preferably also floor-to-ceiling. It can optionally extend all the way up to the roof element, but can also maintain a distance of e.g. 10 cm to 40 cm. The panoramic window can be designed like the window region described above. Particularly preferably, in the region of the panoramic window, at least the dimensionally stable layer of the side wall can be folded outwards, in particular about a horizontal axis located above the window. By opening the panoramic window and folding up the wall element, a panoramic roof is created. In some embodiments, the panoramic window can also form the exit to a roof terrace located behind it on the vehicle roof, if the vehicle has a corresponding length. Alternatively, the panoramic window can also be formed in a side wall made of tent material. In this case as well, the entire panoramic window can preferably be opened, for example by rolling up the material or by opening it outwards. However, it is particularly preferred that the panoramic window can be closed by a dimensionally stable wall element that can be folded upwards and/or downwards, wherein the wall element forms a canopy for the living/sleeping area in the folded-up position. By visually opening the living/sleeping area to the rear using the panoramic window, an attractive living area is created in the rear region of the vehicle.

In an advantageous embodiment, the panoramic window extends over the entire width of a side wall located at the front or rear in the direction of travel, with windows also being arranged in the adjacent regions of the side walls located laterally in the direction of travel. These windows can also be designed like the window regions described herein. In this embodiment, the living/sleeping area is further enhanced since the entire front or rear region of the living/sleeping area has a large panoramic window like a bay window. In one embodiment, there is no longer any supporting structure in the corners of the living/sleeping area so that the panoramic window allows a 180° view with a visor look. In another embodiment, stabilizing elements are provided in the corners, for example inflatable columns. These can be made, for example, from drop-stitch material or from solid air bellows material.

According to one embodiment, the roof element can be transferred from the lower driving position into the raised living/sleeping position by an actuator, in particular a spindle drive or a hydraulic or pneumatic cylinder, wherein the actuator is arranged at a distance of less than 10 cm below the roof element in the raised state. Such actuators for operating pop-up roofs are known. However, in the prior art they are always located at the bottom of the vehicle roof. However, if they are installed directly below the roof shell, they are much better protected from the effects of weather. This makes it possible to provide a safe mechanical-automated lifting mechanism even for a particularly high raised pop-up roof. Preferably, there is a lifting mechanism on each side of the vehicle by which the roof element can be transferred from the driving position into the raised living/sleeping position. This can either be done mechanically-automatically, i.e. with the help of an actuator. Alternatively, the pop-up roof can also be raised by hand, preferably using gas pressure springs to make the raising easier and to hold the roof element in the raised living/sleeping position. Preferably, exactly one lifting mechanism is provided on each side, e.g. a scissor element.

The invention is also directed to a recreational vehicle comprising such a pop-up roof. The preferred recreational vehicle is a panel van, also called a camper van, or a larger car such as a caddy or urban vehicle or trailer.

According to a preferred embodiment, in front of or behind the living/sleeping area of the pop-up roof in the direction of travel, in particular in front of the side wall with the greatest height, there is a roof terrace on the roof of the recreational vehicle, which is accessible from the living/sleeping area. This allows the living/sleeping area to be used even more flexibly and allows the creation of a complete second floor on the recreational vehicle. In particular in combination with the panoramic roof, this creates a completely new living experience.

The invention completely reinterprets the pop-up roof. While it was previously only intended for sleeping or to generate standing height, it now becomes a complete and easily usable living space. The combination with thermally insulating side walls enables permanent options for use in all seasons of the year. Furthermore, new floor plan designs can be achieved, especially in camper vans and camping buses, where the main usage region can be moved to the rear region. The period of use is significantly extended and can extend into winter. Thanks to a roof that is raised higher towards the rear and can be opened and closed manually or automatically, with a minimum height over at least ⅔ of the living/sleeping area at which it is possible to sit upright comfortably, clever ventilation and heating options, as well as new materials, the space on the roof that was previously only used as a place to sleep or to increase standing height is used as genuine living space.

### BRIEF DESCRIPTION OF THE DRAWINGS

The invention is now explained in more detail on the basis of embodiments with reference to the accompanying drawings. Identical or corresponding parts are identified by the same reference signs in the drawings.

In the drawings:

FIG. 1 shows a schematic side view of a camper van with a pop-up roof according to an embodiment of the invention;

FIG. 2 shows a schematic side view of a camper van with a pop-up roof according to an embodiment of the invention;

FIG. 3 shows a schematic side view of a camper van with a pop-up roof according to another embodiment of the invention;

FIG. 4 shows a schematic horizontal cross section through a living/sleeping area with side walls;

FIG. 5 shows a perspective view of a pop-up roof according to an embodiment of the invention;

FIG. 6 shows a schematic perspective view of a pop-up roof according to an embodiment of the invention;

FIG. 7 shows a lifting mechanism of a pop-up roof according to one embodiment of the invention.

### DETAILED DESCRIPTION

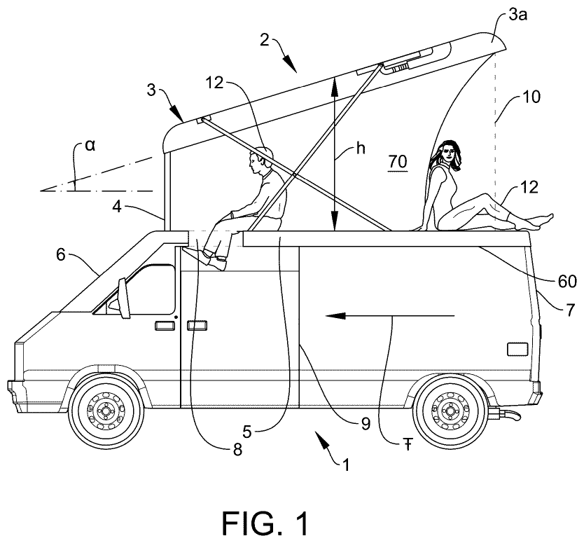

FIG. 1 shows a recreational vehicle 1, here a camper van. The direction of travel is indicated by the arrow F. At front in the direction of travel is the front and driver's cab 6; in the rear in the direction of travel is the rear 7 of the camper van. The sliding door 9 of the camper van is designated with 9. The camper van has a pop-up roof 2 according to an embodiment of the invention. The pop-up roof 2 is mounted on the vehicle roof 60 of the camper van 1. It has a roof element 3 which is shown in the raised living/sleeping position. The roof element is inclined in the direction of travel F of the recreational vehicle by an angle α of approximately 10°. In the shown preferred example, the roof element is higher at the rear in the direction of travel.

The living/sleeping area 70 formed under the roof element 3 is limited at the bottom by the lower shell 5 of the pop-up roof, which is placed on the roof 60 of the panel van 1. A side wall facing the front 6 is designated with 4. There are also side walls at the sides (parallel to the direction of travel), but they are not shown. In the front region of the vehicle roof 60, an entry hatch 8 is provided which allows access from the interior of the recreational vehicle 1 into the living/sleeping area 70 in the pop-up roof 2. The living/sleeping area 70 has at least sitting height over at least two-thirds of its area, as illustrated by the seated persons 12. This has the advantage that the entry hatch 8 can be arranged at the front of the vehicle, as shown in FIG. 1, and yet the living/sleeping area 70 can also be used for sitting in the rear area. In order to further improve this option for use, the pop-up roof has a panoramic window 10 on its side facing the rear 7. The panoramic window 10 extends over the entire width of the rear side wall of the pop-up roof, and in the shown example also over adjacent areas of the side walls to the left and right in the direction of travel, so that the entire rear area of the living/sleeping area 70 can be opened to provide a loggia-like additional living area for persons 12 sitting there.

Camper vans typically have a large rear door at the rear 7, which makes it of interest to use the rear region of the interior of the camper van as living space, e.g. with a sitting area. Correspondingly, the invention also allows the upper living/sleeping area to be oriented to the rear in such a way that a view to the rear can also be used at the top through the panoramic window 10.

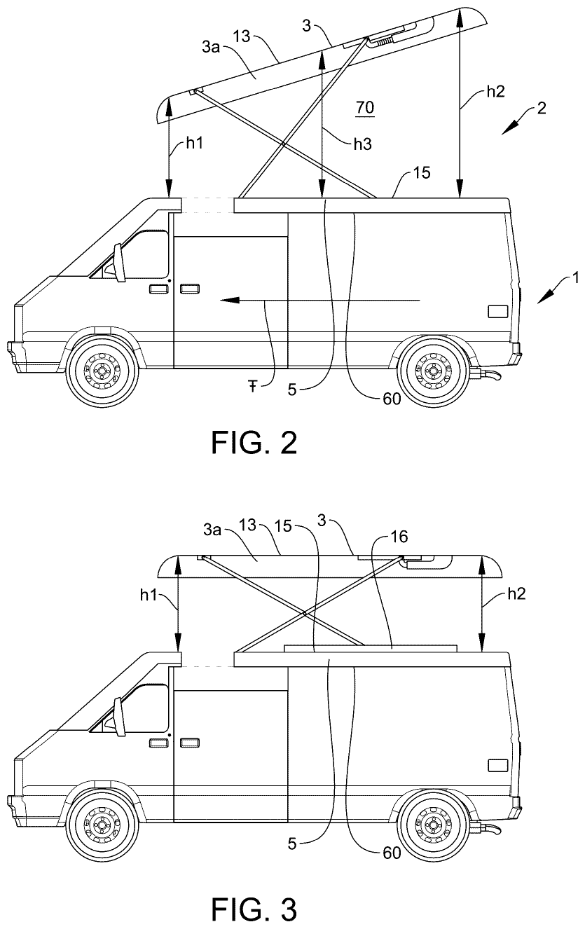

FIG. 2 illustrates again the height h of the living/sleeping area 70 which is formed under the roof element 3. The claimed sitting height is measured in the interior of the living/sleeping area, from the underside 13 of the roof element 3 designed as a roof shell to the upper side 15 of the lower shell 5 of the pop-up roof. Towards the sides, the roof element 3 has a shell edge 3a which surrounds the roof shell 3 and protects an inner cladding of the roof shell 3 as well as the side walls 4 anchored behind it from the weather. The underside 13 of the roof shell is therefore the plane that delimits the living/sleeping area at the top.

The height of the living/sleeping area 70 has at least a sitting height of at least 75 cm over at least two-thirds of its area. This is the minimum height that a person needs to sit. To sit upright, at least 80 cm is preferably required, more preferably at least 85 cm, and even better at least 90 cm. The height h1 can therefore be even lower, e.g. 40 to 70 cm. The height h2 of the highest side wall, in this case the side wall that faces the rear, is on the other hand preferably between 90 cm and 150 cm. h3 shows the height that the specified sitting height has to correspond to, because to the left thereof lies approximately one-third of the area of the living/sleeping area, and to the right thereof, i.e. at the rear in the direction of travel, two-thirds of the area. FIG. 2 shows an embodiment in which the roof element 3 is higher towards the rear 7; of course, embodiments are also conceivable in which the roof element 3 is higher towards the front.

FIG. 3 shows an alternative embodiment in which the roof element 3 is approximately horizontal in the raised position. In this case, the height h1 is at least approximately equal to the height h2 and is at least sitting height. FIG. 3 also shows a mattress 16 which is placed on the lower shell 5 of the pop-up roof.

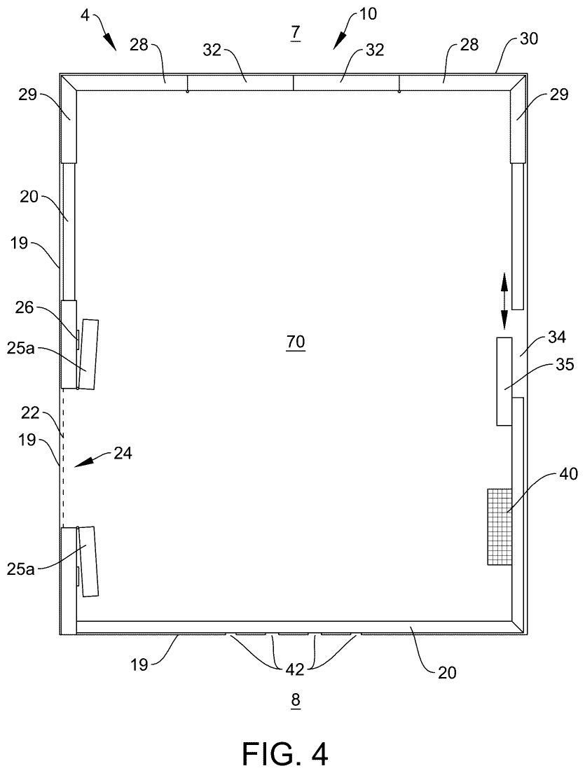

FIG. 4 shows a schematic horizontal cross-section through a living/sleeping room to for example illustrate various features of the side walls and types of window regions in the side walls 4. The living/sleeping area is surrounded on all four sides by a side wall 4, which at least regionally has a dimensionally stable and/or thermally insulating layer and preferably a multi-layer structure. On the outside, the side wall 4 is weatherproof, which can be ensured either by a water-repellent layer 19, e.g. made of tent fabric or window film, or by an impregnation 30 of the side wall. Furthermore, the side walls have a thermally insulating layer 20, 28, 29, 35. This layer is for example between 5 and 30 mm thick and also has a certain dimensional stability. It is preferably not designed to structurally support the roof element, but offers a certain impression of stability as well as increased fall protection for the user. In addition, it has thermal and sound insulating properties, which enhances the living/sleeping area 70. On the inside, the thermally insulating layer can be covered with another textile layer.

At 24 there is a window region. In this window region, the thermally insulating layer 20 of the side wall 4 can be folded inwards to expose a light opening. In this opening, there is preferably a transparent, water-repellent layer 19 on the outside, e.g. made of plastic film or tent fabric film (also called “window film”). A mosquito net 22 may be present behind it. Both the mosquito net 22 as well as the window film 19 can preferably be opened by means of a zipper. In this case, the foldable elements 25a of the thermally insulating layer are folded along two vertical axes like a window shutter. It is advantageous if they are folded inwards. There they can be attached to the inside of the side wall 4 by means of a hook-and-loop fastener 26 or a zipper. This gives the user the opportunity to expose light openings when needed, but maintain good thermal insulation in other situations.

The living/sleeping area preferably has a panoramic window 10 in the direction of the rear 7. In the shown example, this can be opened by folding the entire side wall 28 upwards at the rear. In particularly preferred embodiments, parts of the adjacent lateral side walls 29 are also opened; for example, they can also be folded upwards. In other embodiments, only the rear side wall 28 is folded upwards and thereby forms a canopy. In the shown example, the impregnation 30 or an outer water-repellent layer 30 is also folded upward so that the rear side wall is completely open when the panoramic window is opened. In other embodiments, a window film can be provided on the inside of the side wall 28 which can optionally also not be folded upward therewith. In the position not folded upward of the side wall 28, smaller portions 32 of the side wall 28 can be folded inwards or outwards if necessary to provide a smaller light opening. Preferably, the portions 32 of a thermally insulating layer can be folded inwards, leaving an outer layer protruding from the side wall. The outer layer can for example be formed from window film, as described with reference to the window region 24.

Forced ventilation openings are shown at 42. These may for example be present only in the outer, water-repellent layer 19, while the thermally insulating layer 20 is so highly breathable that no further slits or openings are provided here. In other embodiments, the thermally insulating layer also has corresponding openings. According to a preferred embodiment, the forced ventilation openings 42 can be closed for example by laterally moving a corresponding closure element (e.g. ventilation grille).

At 40, a storage unit is shown on the inside of the wall element on the right-hand side, in this case a net that folds out from the side wall. This means that books or other items can be stored in this area. In one possible embodiment, the storage unit 40 is designed in such a way that it retains a certain capacity even in the lower driving position, i.e. it does not have to be completely removed during the journey.

At 34, yet another window opening is shown, which can be closed by a movable element 35 of the side wall of the thermally insulating layer. For this embodiment, the thermally insulating layer is particularly dimensionally stable, at least in this region, so that it can be moved along a rail located on the floor of the living/sleeping area 70.

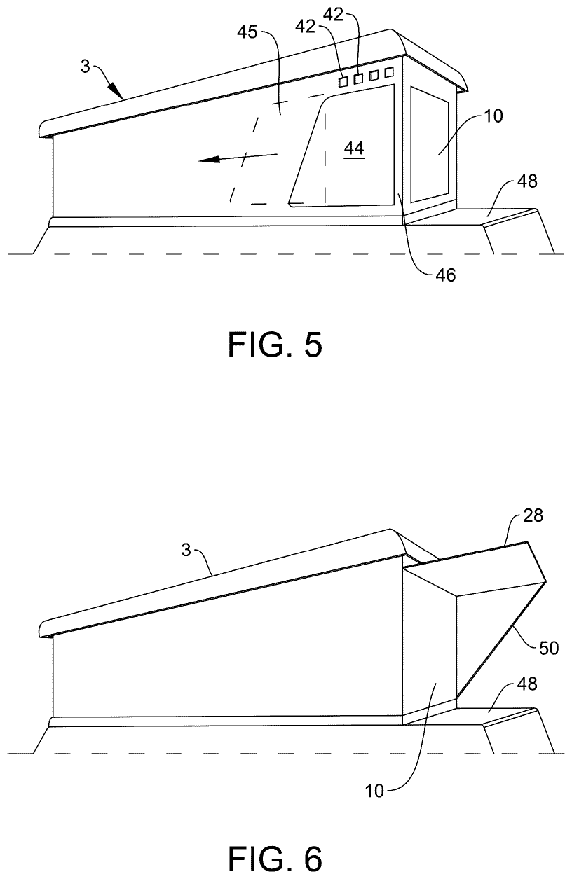

FIG. 5 shows a pop-up roof 2 with an embodiment of a panoramic window 10. In this case, there will be a roof terrace 48 in front of the panoramic window 10 which is located in the side wall with the greatest height, which terrace can be reached through the panoramic window 10. In particular, the roof terrace 48 provides a bench seat at the rear of the vehicle. The panoramic window 10 is extended here by openings 44 in the adjacent side walls. These light openings 44 can in turn be opened by movable elements 45 of a dimensionally stable layer of the side wall. Forced ventilation slots 42 are arranged above the window opening 44. In this embodiment, columns 46 remain between the rear side wall and the lateral side walls, which columns stabilize the side walls. These can be made for example from an inflatable element, for example from drop-stitch material.

FIG. 6 shows an embodiment of a pop-up roof which can be combined with the embodiment in FIG. 5. Here it is shown that the entire rear side wall 28 can be folded upwards to form a canopy. Here the panoramic window 10 thus offers access to a covered loggia 48. In order to hold the side wall 28 in the folded-open position, a rod 25 is provided in this embodiment. In other embodiments, it is also possible to attach the side wall 28 to the roof element 3.

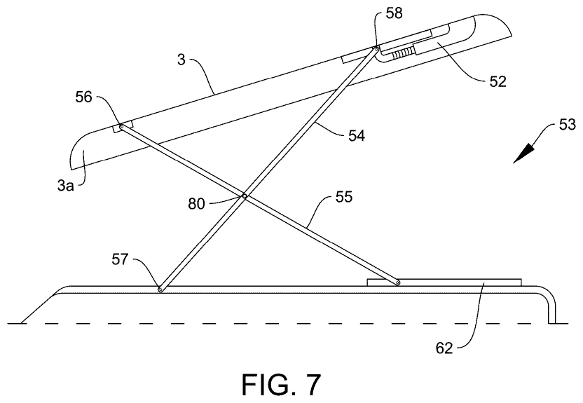

FIG. 7 shows the lifting mechanism 53 with which the roof element 3 can be transferred from the driving position into the raised position, and by which it is also held in the raised living/sleeping position. Preferably, such a lifting mechanism is provided on both sides (left and right in the direction of travel), wherein only one of the two lifting mechanisms 53 requires an actuator 52. However, corresponding actuators 52 can also be provided on both sides. In the shown example, the actuator 52 is a spindle drive by means of which the rod 54 is moved from a retracted position, in which it is arranged parallel to the roof element 3 and directly below the roof element, into the illustrated, extended position. The rod 54 is fixed at point 58 on the spindle drive and crosses at the joint 80 with the counter-rod 55 which is fastened in fixed but rotatable fashion at 56 to the roof element 3. On the roof of the vehicle, the rod 55 can be moved on a rail 60 so that it can also be moved from a horizontal lower driving position to a raised position. According to a preferred embodiment of the invention, the actuator 52 is located at the top and in particular directly under the roof element 3 so that it is ideally protected from weather by the edges 3a of the roof shell 3.

1. A pop-up roof for a recreational vehicle, comprising:
a roof element which is arranged or can be arranged on a roof of a recreational vehicle and can be transferred from a lower driving position into a raised living/sleeping position, wherein in the raised living/sleeping position, a living/sleeping area is formed between the roof element and the roof of the recreational vehicle, which living/sleeping area is accessible from the interior of the recreational vehicle,
at least one side wall which delimits the living/sleeping area to the outside in the raised living/sleeping position,
wherein the living/sleeping area in the raised living/sleeping position has at least one sitting height (h) over at least ⅔ of the living/sleeping area, wherein the sitting height (h) is at least 75 cm, preferably at least 80 cm, more preferably at least 85 cm.

2. The pop-up roof according to claim 1, wherein in the raised living/sleeping position, the roof element is inclined in a direction of travel (F) of the recreational vehicle and in particular has an angle (α) of 4° to 30°, preferably 5° to 20°, to the horizontal.

3. The pop-up roof according to claim 2, wherein in the raised living/sleeping position, the roof element is higher at the rear in the direction of travel.

4. The pop-up roof according to claim 1, wherein the at least one side wall has at least one dimensionally stable and/or thermally insulating layer.

5. The pop-up roof according to claim 1, wherein the at least one side wall has at least one layer made of a self-expanding material.

6. The pop-up roof according to claim 1, wherein a storage unit is integrated on the inside of at least one wall element, in particular a net, a pocket, and/or a fold-out shelf.

7. The pop-up roof according to claim 1, wherein the at least one side wall has a forced ventilation opening which is arranged in particular adjacent to or at a distance of less than 10 cm from the roof element.

8. The pop-up roof according to claim 1, wherein the at least one side wall is at least regionally breathable.

9. The pop-up roof according to claim 1, wherein the at least one side wall has at least one dimensionally stable layer, and wherein in a window region, the at least one dimensionally stable layer of the at least one side wall can be folded inwards and/or outwards, in particular about a substantially horizontal axis.

10. The pop-up roof according to claim 1 further comprising a panoramic window in the at least one side wall, in particular in the at least one side wall with the greatest height, which extends at least over a large part of the width of the at least one side wall or the width of the recreational vehicle.

11. The pop-up roof according to claim 10, wherein the panoramic window can be closed by a wall element that can be folded upwards and/or downwards, wherein the wall element forms a canopy of the living/sleeping area in the folded-up position.

12. The pop-up roof according to claim 10, wherein the panoramic window extends over the entire width of the at least one side wall located at the front or rear in the direction of travel, and wherein windows are also arranged in the adjacent regions of the at least one side wall located laterally in the direction of travel.

13. The pop-up roof according to claim 1, wherein the roof element can be transferred from the lower driving position into the raised living/sleeping position by an actuator, in particular a spindle drive or a pneumatic or hydraulic cylinder, wherein the actuator is arranged at a distance of less than 10 cm below the roof element in the raised state.

14. A recreational vehicle with a pop-up roof according to claim 1, wherein the recreational vehicle is in particular a panel van, camper van, caddy, or urban vehicle.

15. The recreational vehicle according to claim 14, wherein a roof terrace is provided on the roof of the recreational vehicle in front of or behind the living/sleeping area of the pop-up roof in the direction of travel, which the roof terrace is accessible from the living/sleeping area.
